(19) United States
(12) Patent Application Publication
(10) Pub. No.: US 2017/0072483 A1
(43) Pub. Date: Mar. 16, 2017

(54) RECIPROCATING SAW ADAPTOR

(71) Applicant: Lenny J. Gamble, Hicksville, OH (US)

(72) Inventor: Lenny J. Gamble, Hicksville, OH (US)

(21) Appl. No.: 14/855,622

(22) Filed: Sep. 16, 2015

(51) Int. Cl. B23D 51/10; B23D 49/11

(52) U.S. Cl. CPC B23D 51/10; B23D 49/11

(57) ABSTRACT

A reciprocating saw adaptor is provided. The adapter includes an insert blade and a base body. The insert blade includes a first end opposite a second end. The first end is sized to fit within and releasably retain to a reciprocating saw insert region. The base body includes a first end opposite a second end. The first end of the base body is fixed to the second end of the insert blade. The base body includes an opening formed on the second end leading into a threaded internal portion forming a female threaded receiver. The threaded female receiver mates with a threaded male portion of a coping saw.

### BACKGROUND OF THE INVENTION

The present invention relates to power saws and, more particularly, to an adapter to secure a coping saw to a body of a reciprocating saw.

A typical coping saw includes a thin, linear saw blade held under tension in a U-shaped frame having a handle extending away from and generally parallel to the saw blade. To cut a work piece, such as wood, the saw blade is manually pushed and pulled in reciprocating directions. Occasionally, the blade of the coping saw is bent or broken when the blade is unable to cut through the work piece and is jammed or caught. The blade of the coping saw is especially susceptible to bending or breaking when pushed through the work piece. In commercial settings, manual cutting with a coping saw is highly labor intensive, time consuming, and prone to produce repetition-induced injury.

As can be seen, there is a need for an adapter to secure a coping saw to a body of a reciprocating saw.

### SUMMARY OF THE INVENTION

In one aspect of the present invention, a reciprocating saw adaptor comprises: an insert blade comprising a first end opposite a second end, wherein the first end is sized to fit within and releasably retain to a reciprocating saw insert region; and a base body comprising a first end opposite a second end, wherein the first end of the base body is fixed to the second end of the insert blade, wherein the base body comprises an opening formed on the second end leading into a threaded internal portion forming a female threaded receiver.

In another aspect of the present invention, a method of securing a coping saw to a reciprocating saw body comprises: providing a saw adaptor comprising an insert blade fixed to a base body, wherein the base body comprises a female threaded receiver; inserting the insert blade into a reciprocating saw insert region of the reciprocating saw body, thereby releasably attaching the saw adaptor to the reciprocating saw body; and screwing a male threaded portion of a coping saw into the female threaded receiver of the saw adaptor, thereby releasably attaching the coping saw to the reciprocating saw body.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention in use;

FIG. 2 is a detail exploded view of an embodiment of the present invention shown in use;

FIG. 3 is a perspective view of an embodiment of the present invention;

FIG. 4 is a reverse perspective view of an embodiment of the present invention; and

FIG. 5 is a side view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an adapter to attach a coping saw to a reciprocating saw body. The present invention eliminates the fatigue of using a coping saw. The adapter includes a first end including a threaded receiver to screw onto the coping saw. The opposite end is shaped to fit into and attach to a reciprocating saw body. The adapter of the present invention may be made of metal, such as steel and the like, or a hard plastic.

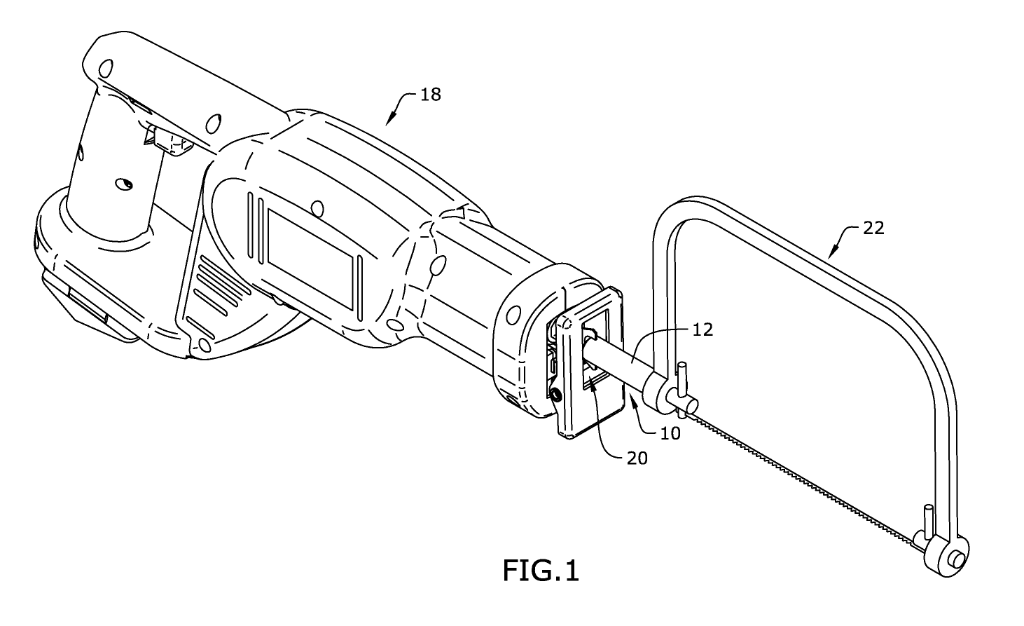

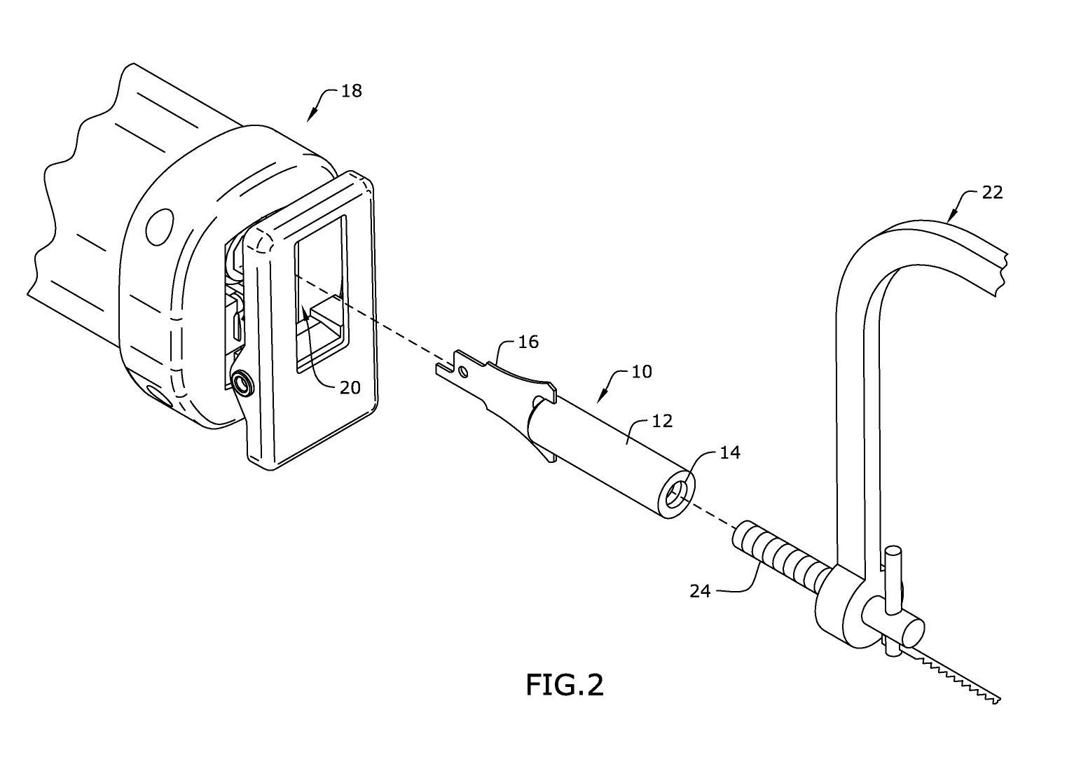

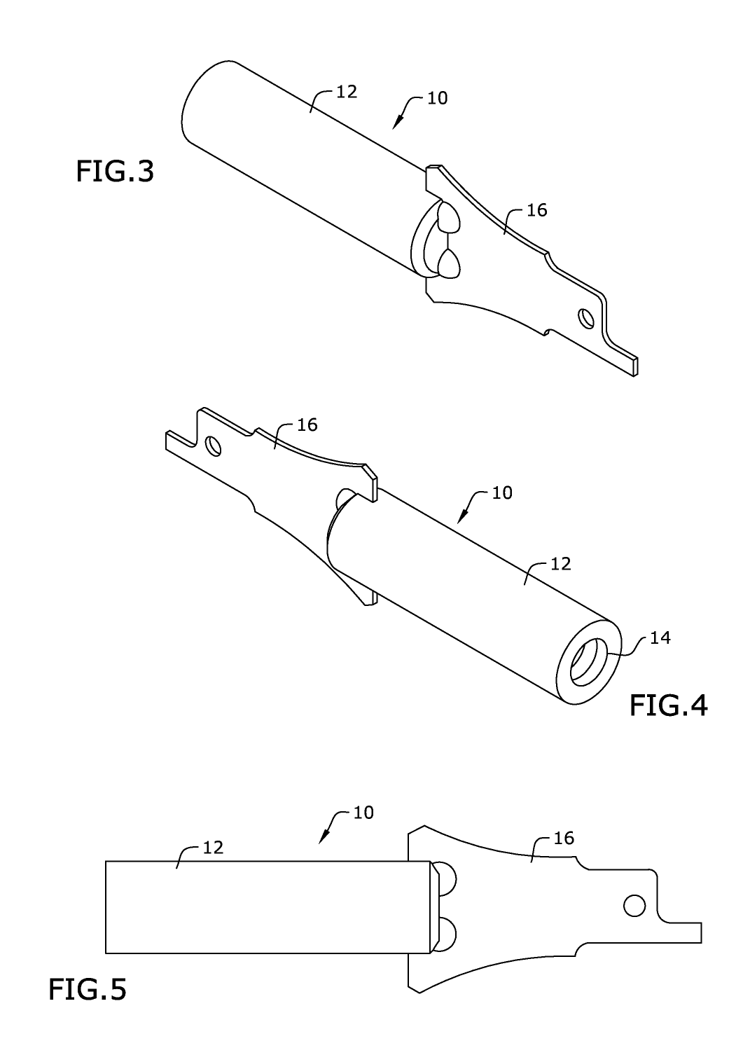

Referring to FIGS. 1 through 5, the present invention includes a reciprocating saw adaptor 10. The adapter 10 includes an insert blade 16 and a base body 12. The insert blade 16 includes a first end opposite a second end. The first end is sized to fit within and releasably retain to a reciprocating saw insert region 20. The base body 12 includes a first end opposite a second end. The first end of the base body 12 is fixed to the second end of the insert blade 16. The base body 12 includes an opening formed on the second end leading into a threaded internal portion forming a female threaded receiver 14. The threaded female receiver 14 mates with a threaded male portion 24 of a coping saw 22.

The reciprocating saw body 18 includes the reciprocating saw insert region 20. Typically, a reciprocating saw fits within the reciprocating saw insert region 20. The reciprocating saw body 18 comprises an actuator that moves the reciprocating saw back and forth. Using the adapter 10 of the present invention, a coping saw 22 is now attachable to the reciprocating saw body 18. Therefore, the reciprocating saw body 18 is able to move the coping saw 22 back and forth.

The insert blade 16 of the adapter may be a substantially flat piece sized to mate with the reciprocating saw insert region 20 of a reciprocating saw body 18. The insert blade 16 may resemble an insert blade of a reciprocating saw. Therefore, the insert blade 16 may include at least one extending arm and an aperture formed on the first end. For example, the insert blade 16 may include two extending arms, depending of the reciprocating saw body 18 to be used. Further, the insert blade 16 may taper from the second end to the first end.

As mentioned above, the base body 12 includes the female threaded receiver 14. The base body 12 as well as the female threaded receiver 14 may include a cylindrical shape. The handle of a coping saw 22 may be unscrewed from the male threaded portion 24 of the coping saw 22. The female threaded receiver 14 is sized to mate with the male threaded portion 24 of the coping saw 22. Therefore, when the insert blade 16 is secured to the reciprocating saw body 18 and the female threaded receiver 14 is secured to the male threaded portion 24 of the coping saw 22, the coping saw 22 is thereby secured and usable with the reciprocating saw body 18.

A method of securing a coping saw to a reciprocating saw body may include the following. A saw adapter mentioned above is provided. The saw adapter includes the insert blade fixed to the base body. The base body includes the female threaded receiver. The insert blade is inserted into the reciprocating saw insert region of the reciprocating saw body, thereby releasably attaching the saw adaptor to the reciprocating saw body. The male threaded portion of the coping saw is unscrewed from the handle of the coping saw. The male threaded portion is then screwed into the female threaded receiver of the saw adapter, thereby releasably attaching the coping saw to the reciprocating saw body.

It should be understood, of course, that the foregoing relates to exemplary embodiments of the invention and that modifications may be made without departing from the spirit and scope of the invention as set forth in the following claims.

What is claimed is:

1. A reciprocating saw adaptor comprising:
an insert blade comprising a first end opposite a second end, wherein the first end is sized to fit within and releasably retain to a reciprocating saw insert region; and
a base body comprising a first end opposite a second end, wherein the first end of the base body is fixed to the second end of the insert blade, wherein the base body comprises an opening formed on the second end leading into a threaded internal portion forming a female threaded receiver.

2. The reciprocating saw adaptor of claim 1, wherein the first end of the insert blade comprises an aperture formed therethrough and at least one extending arm.

3. The reciprocating saw adaptor of claim 1, wherein the insert blade tapers from the second end to the first end.

4. The reciprocating saw adaptor of claim 1, wherein the base body is cylindrical.

5. A method of securing a coping saw to a reciprocating saw body comprising:
providing a saw adaptor comprising an insert blade fixed to a base body, wherein the base body comprises a female threaded receiver;
inserting the insert blade into a reciprocating saw insert region of the reciprocating saw body, thereby releasably attaching the saw adaptor to the reciprocating saw body; and
screwing a male threaded portion of a coping saw into the female threaded receiver of the saw adaptor, thereby releasably attaching the coping saw to the reciprocating saw body.

6. The method of claim 5, wherein the first end of the insert blade comprises an aperture formed therethrough and at least one extending arm.

7. The method of claim 5, wherein the insert blade tapers from the second end to the first end.

8. The method of claim 5, wherein the base body is cylindrical.
